(19) United States
(12) Patent Application Publication
(10) Pub. No.: US 2013/0267652 A1
(43) Pub. Date: Oct. 10, 2013

(54) METHODS OF HYDROPHOBIZING MATERIALS WITH SILOXANES CONTAINING HYDROCARBYLIMINOALKYL OR QUATERNARY AMMONIUM SALTS

(71) Applicant: SAMSUNG ELECTRONICS CO., LTD., Suwon-si (KR)

(72) Inventors: Valeri Alexandrovich VASNEV, Moscow (RU); Boris Alexandrovich IZMAILOV, Moscow (RU); Elena Nikolaevna RODLOVSKAYA, Lubertsy (RU); Galy Dmitrievna MARKOVA, Moscow (RU); Oleg Valerievich BARANOV, Moscow (RU)

(73) Assignee: Samsung Electronics Co., Ltd., Suwon-si (KR)

(21) Appl. No.: 13/855,845

(22) Filed: Apr. 3, 2013

(30) Foreign Application Priority Data
Apr. 4, 2012 (RU) 2012113074
Mar. 26, 2013 (KR) 10-2013-0032411

(51) Int. Cl. C09D 183/08

(52) U.S. Cl. CPC C09D 183/08
USPC 524/588; 427/387

(57) ABSTRACT

A method of coating a surface of a base material, includes:
providing a base material having a surface;
applying a solution of a siloxane oligomer represented by Chemical Formula 1 to the surface of the base material and drying and/or heat-treating the surface comprising the solution of the siloxane oligomer applied thereto to obtain a siloxane-modified surface; and
applying a solution of a hydrocarbyl halide represented by Chemical Formula 2 to the siloxane-modified surface and drying and/or heat-treating the siloxane-modified surface comprising the solution of the hydrocarbyl halide to form a coating including a siloxane polycondensate with a hydrocarbyliminoalkyl moiety or a quaternary ammonium salt moiety:

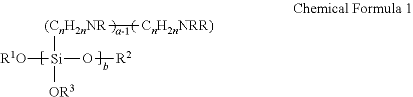

Alk-X Chemical Formula 2

wherein R¹, R², R³, R, n, a, B, Alk, and X are as defined herein.

### CROSS-REFERENCE TO RELATED APPLICATION

This application claims priorities to and the benefits of Russian Patent Application No. 2012113074, filed on Apr. 4, 2012 and Korean Patent Application No. 10-2013-0032411, filed on Mar. 26, 2013, and all the benefits accruing therefrom under 35 U.S.C. §119, the contents of which in their entirety are herein incorporated by reference.

### BACKGROUND

1. Field

This disclosure is directed to polymer materials, in particular, to protective hydrophobic coatings on the surface of materials such as films, fibers, profile products, glass, ceramics, wood, leather, metals, etc. The disclosure also relates methods of manufacture of the coatings and the coated substrates formed therefrom.

2. Description of the Related Art

A hydrophobic material is a type of material that exhibits a high water contact angle at its surface. As a result, water, ice, snow, and the like may not adhere to the surface of hydrophobic materials. Fluoro-containing materials can be hydrophobic materials having a high contact angle to water. However, these fluoro-containing materials are made from expensive raw materials. In addition, providing a coating of a fluoro-containing material to a desired substrate requires sophisticated technology. One of the most popular types of finishing is water-proofing, in which the hydrophobic properties are imparted to the materials while maintaining air flow. Especially urgent is the problem of developing a method of material treatment in which the properties of an applied coating could be implemented in full without losing material integrity, while at the same time maintaining a porous structure of the coated material.

For example, there is a method of textile, for example tissue, hydrophobization with fluorinated alkoxysilane in an environment of supercritical carbon dioxide (Chemical Fibers, 2009, N. 1, pp. 39-44) by applying perfluoroalkylheptaneamide to the surface of a tissue directly from a solution in supercritical carbon dioxide at 35-70° C. under a pressure of from 10 to 22 MPa, with a duration of exposure in the supercritical medium from 1 to 3 hours, and a modifier concentration from 1.25 to 9 mg/cm³. After exposure, decompression of the cell at a rate of 1.2, 0.5, or 0.3 cm³/min with subsequent thermal treatment of the tissue by calendering at 180° C. or warming the surface with hot air at 90° C. for 1 min is undertaken.

As an another example, there is a method of obtaining a protective hydrophobic and oleophobic coating on textile materials, including tissue processing with a solution of fluorine-containing compounds and the subsequent removal of a solvent. In this case, 2,2,3,3,4,4,5,5,6,6,-7,7,7-tridekafluoro-N[3-(triethoxysilyl)propyl]-heptaneamide (CF₃(CF₂)₅—C(O)—NH—(CH₂)₃Si(OC₂H₅)₃) is used as the fluorine-containing compound. The solvent is an organic solvent such as ethyl alcohol, isopropyl alcohol, acetone, tetrahydrofuran, or toluene. After the solvent removal, the additional fixation of a hydrophobic and oleophobic material is undertaken by treatment with hot air at 90° C. or by calendering at 180° C. (Patent N 2394956 (2010), The Russian Federation). The disadvantages of the above methods include the need to conduct the process of tissue finishing under pressure, and the high cost of the fluorinated modifier and its high consumption.

As an another example, a method of treating textile materials with oligo(alkylmethylene)siloxanes solutions or water emulsions has been disclosed by Izmailov, B. A., Nedelkin, A. V., and Yambulatova, O. V., Hydrophobic finishing of textile materials from cotton and half-woolen fibers with higher oligo(alkylmethylene)siloxanes/Proceedings of higher educational institutions, The Technology of Textile Industry, 2009, N. 2, pp. 43-46. The concentration of the solutions was 1-3%, and the concentration of the water emulsions was 1-5%. The maximum hydrophobic characteristics of the tissue reached 21-25 kPa of water column determined by penetrometer, and water absorption was 20-30%. For untreated tissue, the values were 0 and 80-90%, respectively, determined according to GOST 3816-81. The disadvantage of this method is a large consumption of the modifier. Thus, there remains a need for a convenient and cost effective method to impart hydrophobicity to a surface of a substrate.

### SUMMARY

An embodiment provides a method of forming a hydrophobic coating on a surface of various base materials.

Another embodiment provides a hydrophobic coating formed on a surface of various base materials.

According to an embodiment, a method of coating a surface of a base material includes:

providing a base material having a surface;

applying a solution of a siloxane oligomer represented by Chemical Formula 1 to the surface of the base material and drying and/or heat-treating the surface comprising the solution of the siloxane oligomer to obtain a siloxane-modified surface; and

applying a solution of a hydrocarbyl halide represented by Chemical Formula 2 to the siloxane-modified surface and drying and/or heat-treating the siloxane-modified surface comprising the solution of the hydrocarbyl halide to form a coating comprising a siloxane polycondensate comprising a hydrocarbyliminoalkyl moiety or a quaternary ammonium salt-substituted hydrocarbyl moiety.

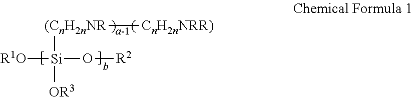

In Chemical Formula 1,

R¹, R², and R³ are the same or different and are each independently hydrogen or a C1 to C10 alkyl group, R is the same or different and each is independently hydrogen or a C1 to C10 alkyl group, n is an integer of 1 to 5, a is an integer of 1 to 3, and b represents a polymerization degree of the siloxane oligomer, being an integer of 2 to 30.

Alk-X Chemical Formula 2

In Chemical Formula 2, Alk is a C4 to C24 alkyl group, a C4 to C24 alkenyl group, or a C4 to C24 alkynyl group, and X is F, Cl, Br, or I.

The base material may include an organic material, an inorganic material, or an organic-inorganic hybrid material, and may have a hydroxyl group, a carboxyl group, or a combination thereof on the surface thereof.

The siloxane oligomer represented by Chemical Formula 1 may be oligo(aminopropyl)ethoxysilane, or similarly, an oligo(aminopropyl)methoxysilane, oligo(aminoethyl)methoxysilane, oligo(aminoethyl)ethoxysilane, oligo(aminobutyl)ethoxysilane, oligo(aminobutyl)methoxysilane, oligo(aminopentyl)ethoxysilane, oligo(aminopentyl)methoxysilane, oligo(aminoalkyl)alkoxysilane represented by either of the following chemical formulae, or a combination thereof:

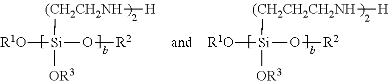

wherein R¹, R², and R³ are the same or different and are each independently hydrogen or a C1 to C10 alkyl group, and b is an integer of 2 to 30.

The siloxane oligomer may have a polymerization degree of 4 to 16.

The hydrocarbyl halide may be a C4 to C22 alkyl bromide, a C4 to C22 alkenyl bromide, or a C4 to C22 alkynyl bromide

The method may further include preparing the solution of the siloxane oligomer by dissolving or dispersing the siloxane oligomer in an organic solvent that dissolves or disperses the siloxane oligomer.

The organic solvent that dissolves or disperses the siloxane oligomer may be a linear or branched C1 to C10 alcohol, a C3 to C10 ketone, a C3 to C10 ester, a linear or cyclic C3 to C10 ether, a C6 to C10 aromatic hydrocarbon, a C2 to C5 nitrile, a C2 to C10 sulfoxide, a C4 to C10 carbonate, or a combination thereof.

The organic solvent that dissolves or disperses the siloxane oligomer may be methanol, ethanol, n-propanol, isopropanol, n-butanol, acetone, butanone, methyl acetate, ethyl acetate, butyl acetate, tetrahydrofuran, dioxane, diethyl ether, methyl-butyl ether, benzene, toluene, xylene, acetonitrile, propylene carbonate, dimethylsulfoxide, or a combination thereof.

The applied amount of the siloxane oligomer per one cm² of the surface of the base material may be less than or equal to about 1.0×10⁻³ mol.

The surface having the solution of the siloxane oligomer applied thereto may be dried and/or heat-treated at a temperature of about 20° C. or higher to provide the siloxane-modified surface including the siloxane oligomer or a polysiloxane derived from the siloxane oligomer, the siloxane, or the polysiloxane being covalently bonded to the surface of the base material.

The method may further include preparing the hydrocarbyl halide solution by dissolving the hydrocarbyl halide in a solvent that dissolves the hydrocarbyl halide, wherein the solvent optionally comprises an amide group represented by formula —CONH—.

The solvent without an amide group represented by formula —CONH— that dissolves the hydrocarbyl halide may be a linear or branched C1 to C10 alcohol, a C3 to C10 ketone, a C3 to C10 ester, a linear or cyclic C3 to C10 ether, a C6 to C10 aromatic hydrocarbon, a C2 to C5 nitrile, a C2 to C10 sulfoxide, a C4 to C10 carbonate, or a combination thereof, and the solvent comprises an amide group represented by formula —CONN— that dissolves the hydrocarbyl halide may be dimethylformamide, diethylformamide, dimethylacetamide, diethylacetamide, N-methylpyrrolidone, or a combination thereof.

The hydrocarbyl halide solution may be applied to the siloxane-modified surface in such an amount that the applied amount of alkyl halide is greater than or equal to about 0.5 mole per one mole of an amine nitrogen of the siloxane oligomer.

The siloxane-modified surface comprising the solution of the hydrocarbyl halide applied thereto may be dried and/or heat-treated at a temperature of greater than or equal to about 20° C. to form the coating including the siloxane polycondensate, which includes a repeating unit represented by Chemical Formula 3 or a repeating unit represented by Chemical Formula 4, and is covalently bonded to the surface of the base material:

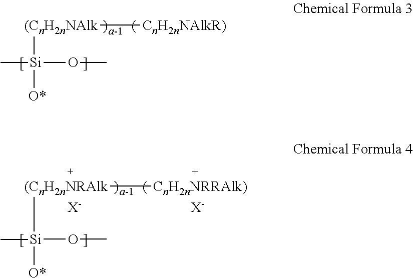

wherein R is the same or different and each is independently hydrogen or a C1 to C10 alkyl group, n is an integer of 1 to 5, a is an integer of 1 to 3, Alk is a C4 to C24 hydrocarbyl group, X is F, Cl, Br, or I, and each asterisk (“*”) independently represents a point of attachment to the surface of the base material, a hydrogen, or a C1 to C10 alkyl provided that at least one asterisk is a point of attachment to the surface of the base material.

According to an embodiment, a hydrophobic coating formed on a surface of a base material includes a siloxane polycondensate including a repeating unit represented by Chemical Formula 3 or a repeating unit represented by Chemical Formula 4, and the siloxane polycondensate is covalently bonded to the surface of the base material:

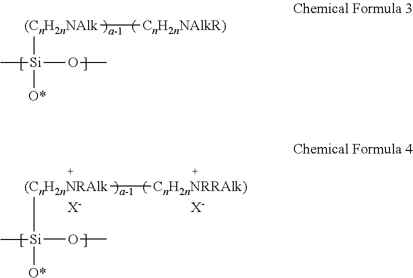

wherein R is the same or different and each independently hydrogen or a C1 to C10 alkyl group, n is an integer of 1 to 5, a is an integer of 1 to 3, Alk is a C4 to C24 hydrocarbyl group, X is F, Cl, Br, or I, and each asterisk (“*”) independently represents a point of attachment to the surface of the base material or a hydrogen or a C1 to C10 alkyl provided that at least one asterisk is a point of attachment to the surface of the base material.

The base material may be an organic material, an inorganic material, or an organic-inorganic hybrid material, and has a hydroxyl group, a carboxyl group, or a combination thereof as a functional group on the surface thereof.

The base material may be a polymer, wood, leather, glass, a metal, a metal oxide or metal nitride, a ceramic material, or a combination thereof.

Alk may be a C4 to C22 alkyl group, a C4 to C22 alkenyl group, or a C4 to C22 alkynyl group, and X may be Br.

The coating may have a water contact angle of greater than or equal to about 90°.

### BRIEF DESCRIPTION OF THE DRAWING

FIG. 1 shows a graph of water contact angle versus the number of carbon atoms of a terminal alkyl group in a coating formed in accordance with Examples 1 to 10.

### DETAILED DESCRIPTION

The advantages and characteristics of the present disclosure, and the methods of achieving them, will be clearly understood referring to the accompanying drawings and exemplary embodiments. However, the present disclosure is not limited to the following exemplary embodiments, and it may be realized with different embodiments. The present exemplary embodiments are provided to complete the disclosure and aid understanding of a person of ordinary skill in the art to fully understand the scope of the disclosure, and are not intended to limit the scope of the present claims. Thus, in some exemplary embodiments, well-known technologies are not specifically explained to avoid ambiguous understanding of the present disclosure. Unless otherwise defined, all terms used in the specification (including technical and scientific terms) may be used with meanings commonly understood to a person having ordinary knowledge in the art. Further, unless explicitly defined otherwise, the terms defined in a generally-used dictionary are not ideally or excessively interpreted.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

The terminology used herein is for the purpose of describing particular embodiments only and is not intended to be limiting. As used herein, the singular forms “a,” “an” and “the” are intended to include the plural forms as well, unless the context clearly indicates otherwise. The term “or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “combination thereof” means that a combination comprising at least one of the listed elements is present, optionally together with a like element not listed.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Alkyl” as used herein means a monovalent group derived from a straight or branched chain saturated aliphatic hydrocarbon having the specified number of carbon atoms.

“Alkenyl” as used herein means a straight or branched chain, monovalent hydrocarbon group having at least one carbon-carbon double bond (e.g., butenyl).

“Alkynyl” means a straight or branched chain, monovalent hydrocarbon group having at least one carbon-carbon triple bond (e.g., butynyl).

As used herein, the term “hydrocarbyl” refers to an alkyl residue, an alkenyl residue, or an alkynyl residue.

In an embodiment, a method of coating a surface of a base material includes:

providing a base material having a surface;

applying a solution of a siloxane oligomer represented by Chemical Formula 1 to the surface of the base material and drying and/or heat-treating the surface comprising the solution of the siloxane oligomer to obtain a siloxane-modified surface; and

applying a solution of a hydrocarbyl halide represented by Chemical Formula 2 to the siloxane-modified surface and drying and/or heat-treating the siloxane-modified surface comprising the solution of the hydrocarbyl halide to form a coating comprising a siloxane polycondensate comprising a hydrocarbyliminoalkyl group or a hydrocarbyl group substituted with a quaternary ammonium salt group. In an embodiment, the quaternary ammonium salt-substituted hydrocarbyl moiety comprises, or consists of, a hydrocarbyl ammonium cation and a halide anion.

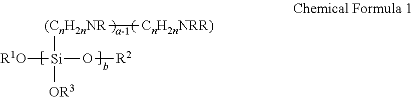

In Chemical Formula 1, R¹, R², and R³ are the same or different, and are each independently hydrogen or a C1 to C10 alkyl group, specifically a C1 to C3 alkyl group, R is the same or different and each is independently hydrogen or a C1 to C10 alkyl group, specifically a C1 to C3 alkyl group, n is an integer of 1 to 5, specifically 1 to 3, a is an integer of 1 to 4, specifically 1 or 2, and b represents a polymerization degree of the siloxane oligomer, being an integer of 2 to 30, specifically 4 to 16.

Alk-X Chemical Formula 2

In Chemical Formula 2, Alk is a C4 to C24 alkyl group, a C4 to C24 alkenyl group, or a C4 to C24 alkynyl group, and X is F, Cl, Br, or I.

The base material may comprise a hydroxyl group, a carboxyl group, or a combination thereof on its surface. The base material may be an organic material, an inorganic material, or an organic-inorganic hybrid material. Specifically, the base material may be various polymers such as polyester (e.g., polyethylene terephthalate), polyethylene, polypropylene, polycarbonate, polyvinylchloride, polyvinyl alcohol, polymethyl(meth)acrylate, cellulose, a modified cellulose, polystyrene, or poly(acrylonitrile-butadiene-styrene) (ABS resin), wood, leather, glass, a metal, a metal oxide or a metal nitride such as SiO₂, TiO₂, SnO₂, Fe₂O₃, Al₂O₃, an AAO (anodic aluminum oxide), and SiN₄, a ceramic material, or a combination thereof, but is not limited thereto. When the polymer does not have a hydroxyl group and/or a carboxy group, the polymer may be modified so as to have a hydroxyl group and/or a carboxyl group. The base material may have any shape such as a fiber, a film, a plate, a sphere, a cube, a cuboid, or a polyhedron, or may be a profiled product having an irregular shape, but is not limited thereto. The base material may be subjected to a surface treatment so as to have a hydroxyl group, a carboxyl group, or a combination thereof on its surface. Non-limiting examples of the surface treatment may include a corona treatment, an ultraviolet (UV) treatment, a plasma treatment, or a chemical treatment using hydrogen peroxide, hexafluoride isopropanol, or an acid such as diluted sulfuric acid.

A solution of the siloxane oligomer represented by the above Chemical Formula 1 is applied to the surface of the base material and then is dried and/or heat-treated to prepare a siloxane-modified surface of the base material. The siloxane oligomer represented by Chemical Formula 1 may be selected from oligo(aminopropyl)ethoxysilane, or similarly, oligo(aminopropyl)methoxysilane, oligo(aminoethyl)methoxysilane, oligo(aminoethyl)ethoxysilane, oligo(aminobutyl)ethoxysilane, oligo(aminobutyl)methoxysilane, oligo(aminopentyl)ethoxysilane, oligo(aminopentyl)methoxysilane, an oligo(aminoalkyl)alkoxysilane represented by either of the following chemical formulae, and a combination thereof:

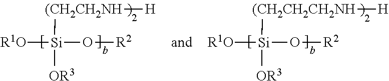

wherein R₁, R₂, and R₃ are the same as or different from each other and are each independently hydrogen or a C1 to C3 alkyl group, and b is an integer of 2 to 30, specifically 4 to 16. Such a siloxane oligomer may be prepared by reacting a proper amount of a corresponding aminoalkyl alkoxy silane in the presence of a proper amount of water. The amount of the silane compound, the amount of water, the reaction conditions, and the reaction time may be selected in light of a desired degree of polymerization of the siloxane oligomer. Details for the synthesis method thereof are known in the art.

The solution of the siloxane oligomer may be prepared by dissolving or dispersing a given siloxane oligomer in an organic solvent that may dissolve or disperse the given siloxane oligomer. As used herein, a “solution” includes a dispersion. The types of the organic solvent are not particularly limited so long as it may dissolve or disperse the siloxane oligomer. For example, the organic solvent may be a linear or branched C1 to C10 alcohol, a C3 to C10 ketone, a C3 to C10 ester, a linear or cyclic C3 to C10 ether, a C6 to C10 aromatic hydrocarbon, a C2 to C5 nitrile, a C2 to C10 sulfoxide, a C4 to C10 carbonate, or a combination thereof. Specific examples of the organic solvent may include, but are not limited to, methanol, ethanol, n-propanol, isopropanol, n-butanol, acetone, butanone, methyl acetate, ethyl acetate, butyl acetate, tetrahydrofuran, dioxane, diethyl ether, methyl-butyl ether, benzene, toluene, xylene, acetonitrile, propylene carbonate, dimethylsulfoxide, and a combination thereof.

The concentration of the siloxane oligomer solution is not particularly limited, but it may range from about 0.05 wt % to about 10 wt %, and specifically about 0.1 wt % to about 2 wt %, based on the total weight of the solution. The method for applying the siloxane oligomer solution to the surface of the base material is not particularly limited, and the surface of the base material may be wetted with the siloxane oligomer solution by using any proper means such as immersion, coating (e.g., a spin coating, a dip coating, a spraying), or solution dropping. The conditions for the application may be selected depending on the specific application method. By way of an example, the solution dropping may be carried out at a temperature of about 10° C. to about 70° C. for a time period of about one minute to about 30 minutes. In an exemplary embodiment, the aforementioned method may impart a high level of hydrophobicity even when a small amount of the siloxane oligomer is applied to the surface of the base material. For example, the applied amount of the siloxane oligomer per 1 cm² of the surface area of the base material may be less than or equal to about 1.0×10⁻³ mol, specifically less than or equal to 1×10⁻⁴ mol, and more specifically less than or equal to about 0.5×10⁻⁵ mol. The applied amount of the siloxane oligomer may be greater than or equal to about 3.7×10⁻⁹ mol.

The surface of substrate comprising the siloxane oligomer solution (e.g., the surface of the substrate wetted with the siloxane oligomer solution) may be subjected to a drying and/or heat treatment to provide a siloxane modified surface. Via such a drying and/or heat treatment, the siloxane oligomer or a polysiloxane derived therefrom may be chemically fixed to the substrate. As used herein, the term “chemically fixing” refers to linking a corresponding compound to the surface by a chemical bond such as a covalent bond. The temperature for the drying or the heat treatment may be appropriately selected, and may be about 20° C. or higher, specifically about 30° C. or higher, more specifically 100° C. or higher, and even more specifically 120° C. or higher, but it is not limited thereto. The time for the drying or the heat treatment is not particularly limited and may be properly selected depending on the temperature of the drying or the heat treatment. By way of an example, the time for the drying or the heat treatment may be about 30 seconds or longer, specifically about one minute or longer, more specifically about 3 minutes or longer, and even more specifically about 5 minutes or longer depending on the temperature of the drying or the heat treatment, but it is not limited thereto. By way of an example, the time for the drying or the heat treatment may be less than or equal to about 72 hours, specifically less than or equal to about 48 hours, more specifically less than or equal to about 24 hours, and even more specifically less than or equal to about 12 hours depending on the temperature of the drying or the heat treatment, but it is not limited thereto.

In a non-limiting example, using an aminopropyl triethoxysilane oligomer having n repeat units to prepare a siloxane modified surface may be illustrated by Reaction Scheme 1 as below.

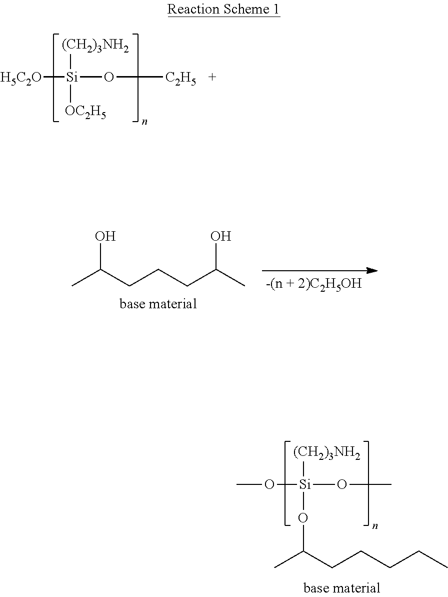

By way of another non-limiting example, using deca(aminopropyl)dodecaethoxydecasiloxane to prepare a siloxane-modified surface may be illustrated by Reaction Scheme 2 as below.

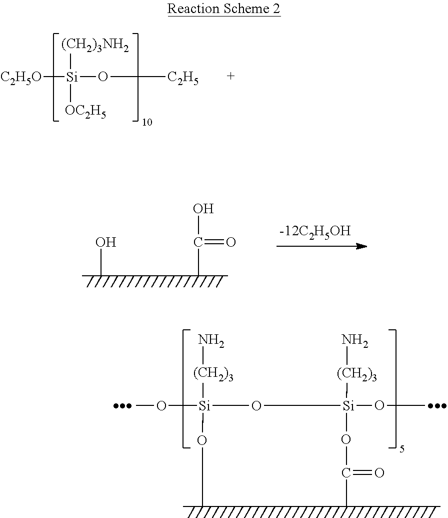

In Reaction Scheme 2, a modifier (i.e., deca(aminopropyl)dodecaethoxydecasiloxane) is deposited on the wetted surface of the base materials directly from its solution in an organic solvent. After the drying and/or the heat-treatment, the modifier is covalently attached to the surface of the base material due to condensation of the ethoxy-groups of the modifier with the functional groups (—OH, —COOH) of the base material, thereby modifying the surface of the base material with the aminopropyl-containing organosiloxane (e.g., a micro- or nano-thick organosiloxane coating). If desired, the siloxane-modified surface as formed may be washed with water or other various organic solvents. The conditions and the manners for the washing are not particularly limited, and may be properly selected.

Then, a solution of the hydrocarbyl halide represented by Chemical Formula 2 is applied to the siloxane-modified surface. The hydrocarbyl halide may be an alkyl halide, an alkenyl halide, an alkynyl halide, or a combination thereof. The hydrocarbyl halide may a C4 to C22 alkyl bromide such as butyl bromide, octyl bromide, tetradecyl bromide, octadecyl bromide, or behenyl bromide; a C4 to C22 alkenyl bromide; or a C4 to C22 alkynyl bromide.

The hydrocarbyl halide solution may be prepared by dissolving the hydrocarbyl halide in a solvent that dissolves the hydrocarbyl halide, wherein the solvent optionally comprises an amide group represented by formula —CONN—. Using the solvent without an amide group enables the formation of a siloxane polycondensate comprising a quaternary ammonium salt moiety, as will be explained below. The solvent without an amide group may be a linear or branched C1 to C10 alcohol, a C3 to C10 ketone, a C3 to C10 ester, a linear or cyclic C3 to C10 ether, a C6 to C10 aromatic hydrocarbon, a C2 to C5 nitrile, a C2 to C10 sulfoxide, a C4 to C10 carbonate, or a combination thereof. Specific examples of such organic solvent may include methanol, ethanol, n-propanol, isopropanol, n-butanol, acetone, butanone, methyl acetate, ethyl acetate, butyl acetate, tetrahydrofuran, dioxane, diethyl ether, methyl-butyl ether, benzene, toluene, xylene, acetonitrile, propylene carbonate, dimethylsulfoxide, or a combination thereof.

In contrast, using the organic solvent comprising an amide group enables the resulting siloxane polycondensate to have a hydrocarbyl imino alkyl group. Specific examples of the organic solvent with an amide group may include dimethylformamide (DMF), diethylformamide, dimethylacetamide (DMAc), diethylacetamide, N-methylpyrrolidone (NMP), or a combination thereof.

The concentration of the hydrocarbyl halide solution is not particularly limited, and it may range from about 0.01 wt % to about 20 wt %, and specifically about 0.1 wt % to about 10 wt %. The method for applying the hydrocarbyl halide solution to the modified surface of the base material is not particularly limited, and the specific manners and the conditions are the same as set forth for the application of the solution containing the siloxane oligomer.

In an exemplary embodiment, the method may impart a high level of hydrophobicity to the surface of the base material even when a small amount of hydrocarbyl halide is applied thereto. The hydrocarbyl halide solution may be applied to the siloxane-modified surface in such an amount that the applied amount of alkyl halide is greater than or equal to about 0.5 mole, specifically greater than or equal to about 0.9 mole, more specifically greater than or equal to about 1 mole, even more specifically greater than or equal to about 2 mole, most specifically greater than or equal to about 3 mole, per one mole of an amine nitrogen of the siloxane oligomer. As used herein, the siloxane oligomer in the phrase “per one mole of amine nitrogen of the siloxane oligomer” refers to the siloxane oligomer applied to the surface of the base material.

The siloxane-modified surface comprising the solution of the hydrocarbyl halide applied thereto may be dried and/or heat-treated to trigger a reaction between the hydrocarbyl halide and the alkyl amino moiety of the siloxane-modified surface, and as a result, a coating comprising a siloxane polycondensate comprising a hydrocarbyl iminoalkyl moiety or a siloxane polycondensate comprising a quaternary ammonium salt-substituted hydrocarbyl moiety may be formed on the surface of the base material.

During the drying and/or the heat-treatment, the formed siloxane polycondensate may comprise either a hydrocarbyliminoalkyl moiety or a quaternary ammonium salt-substituted hydrocarbyl moiety depending on the types of the solvent used for the hydrocarbyl halide solution. That is, when the hydrocarbyl halide solution is prepared using the organic solvent without an amide group such as an alcohol or toluene, the resulting siloxane polycondensate contained in the coating may have a quaternary ammonium salt moiety. In contrast, when the hydrocarbyl halide solution is prepared by using an organic solvent comprising an amide group such as DMF or DMAc, the siloxane polycondensate contained in the coating may have a hydrocarbyl iminoalkyl moiety. Specific examples of the organic solvent without an amide group are the same as set forth in the above. Likewise, specific examples of the organic solvent comprising an amide group are the same as set forth in the above.

The temperature of the drying or the heat treatment may be appropriately selected, and may be about 20° C. or higher, specifically about 30° C. or higher, more specifically about 100° C. or higher, and even more specifically about 120° C. or higher, but it is not limited thereto. The time for the drying or the heat treatment is not particularly limited and may be properly selected depending on the temperature of the drying or the heat treatment. By way of an example, the time for the drying or the heat treatment may be about 30 seconds or longer, specifically about one minute or longer, more specifically about 3 minutes or longer, and even more specifically about 5 minutes or longer depending on the given temperature, but it is not limited thereto. By way of an example, the time for the drying or the heat treatment may be less than or equal to about 72 hours, specifically less than or equal to about 48 hours, more specifically less than or equal to about 24 hours, and even more specifically less than or equal to about 12 hours depending on the given temperature, but it is not limited thereto.

By way of a non-limiting example, when aminopropyl ethoxy siloxane oligomer is used as the siloxane oligomer and an alkyl bromide having 4 carbon atoms, 8 carbon atoms, or 18 carbon atoms is used as the hydrocarbyl halide, it is possible to form a coating comprising a siloxane polycondensate comprising a quaternary ammonium salt moiety or a siloxane polycondensate comprising an alkyliminoalkyl moiety in accordance with Reaction Scheme 3 as follows.

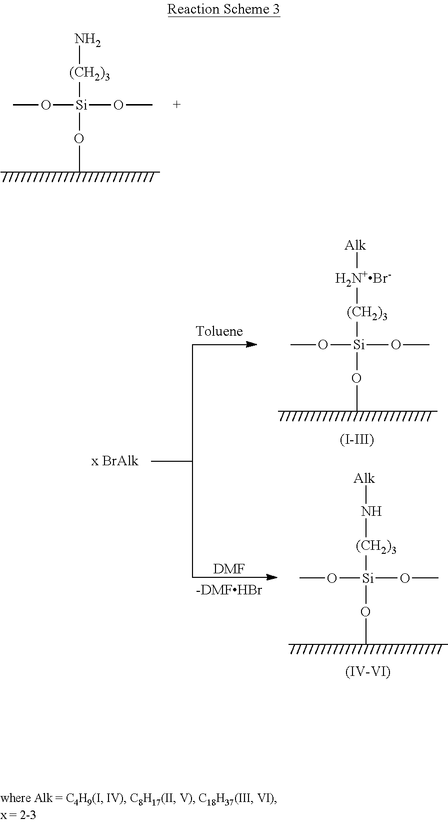

The coating and the drying and/or heat-treatment may be carried out at least once. By way of an example, after a first drying and/or heat treatment is conducted at a predetermined temperature, the coating thus obtained may be washed and/or dried, and then a second coating and a second drying and/or heat treatment may be conducted at a predetermined temperature. In this case, it is possible to obtain a thick coating with excellent qualities.

The thickness of the resulting coating may be properly adjusted as required and is not particularly limited. The aforementioned coating method makes it possible to easily obtain an extremely thin coating (e.g., with a thickness of a nanometer) and a thick coating as well. By way of non-limiting examples, the resulting coating may be thin with a thickness of about 1 nm or higher, for example, about 30 nm or higher. In addition, the coating may have a thickness of 1,000 nm or higher. The coating obtained in accordance with the foregoing method may exhibit excellent hydrophobicity even when it is formed using a tiny amount of a starting material, for example, the siloxane oligomer, or the hydrocarbyl halide and thus its thickness can be very small.

If desirable, the coating thus obtained may be washed with water or other various organic solvents and then dried. The conditions and the manners of the washing are not particularly limited but may be appropriately selected. Moreover, the conditions and the manners of drying are not particularly limited but may be appropriately selected. By way of an example, the coating may be dried in the air at a temperature of about 10° C. or higher for about 30 minutes or longer, specifically about an hour or longer, for example, for about 12 hours.

The coating thus obtained may exhibit a very high level of hydrophobicity. For example, the coating including the siloxane polycondensate with the quaternary ammonium salt may exhibit a water contact angle of greater than or equal to about 90°, specifically greater than or equal to about 91°, more specifically greater than or equal to about 92°, and most specifically greater than or equal to about 97°. Even without containing fluorine, the coating may show a water contact angle as high as about 120°, the highest value of a water contact angle that a smooth surface may have.

Without being bound by any theory, the coating containing the siloxane polycondensate may exhibit such a high level of hydrophobicity because the hydrocarbyl groups (e.g., an alkyl, alkenyl, or alkynyl group) may align or orient in a vertical or nearly vertical direction to the surface of the substrate. The degree of hydrophobicity may vary with the types of the groups contained in the siloxane polycondensate (e.g., a quaternary ammonium salt). For example, the degree of the hydrophobicity may depend on the number of carbon atoms of the terminal hydrocarbyl group.

Even when using a small amount (e.g., millimole or micromole) of starting materials, for example, siloxane oligomer or hydrocarbyl halide, the surface coating method may realize a very high level of hydrophobicity (e.g., a water contact angle value which only the fluoro-containing modifier may exhibit) and therefore it may be used in various applications requiring a high level of hydrophobicity at the surface of a base material. In addition, it is possible to impart a high level of hydrophobicity to the base material with no damage to the integrity of the base material (for example, without any loss in the porosity of the base material), as a small amount of the modifier may be used.

According to another embodiment, a hydrophobic coating formed on a surface of a base material comprises a siloxane polycondensate comprising a repeating unit represented by Chemical Formula 3 or a repeating unit represented by Chemical Formula 4, and the siloxane polycondensate is covalently bonded to the surface of the base material:

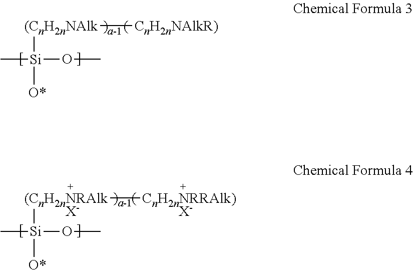

wherein R is the same or different and each is independently hydrogen or a C1 to C10 alkyl group, specifically a C1 to C3 alkyl group, n is an integer of 1 to 5, specifically 1 to 3, a is an integer of 1 to 3, specifically 1 or 2, Alk is a C4 to C24 alkyl group, a C4 to C24 alkenyl group, or a C4 to C24 alkynyl group, X is F, Cl, Br, or I, and each asterisk (“*”) independently represents a point of attachment to the surface of the base material or a hydrogen or a C1 to C10 alkyl, specifically a C1 to C3 alkyl, provided that at least one asterisk is a point of attachment to the surface of the base material.

Details for the base material and details for the method of forming the coating are the same as set forth herein above.

In Chemical Formula 3 and Chemical Formula 4, Alk may be a C4 to C22 alkyl group, a C4 to C22 alkenyl group, or a C4 to C22 alkynyl group, and X may be Br.

The hydrophobic coating may exhibit a very high level of hydrophobicity (e.g., water contact angle) even when a small amount of the siloxane oligomer is used. The coating comprising the siloxane polycondensate with the quaternary ammonium salt may exhibit a far higher level of water contact angle. That is, the coating comprising the siloxane polycondensate comprising the quaternary ammonium salt moiety may exhibit a water contact angle of at least about 90°, specifically at least about 91°, more specifically at least about 92°, and even more specifically at least about 93°. In particular, the coating comprising the siloxane polycondensate comprising the quaternary ammonium salt moiety may have a water contact angle of about 120° or higher even without a fluorine atom, and thus it may find its utility in a wide range of products that require preventing water, ice, and water vapor from sticking to their surface. A water contact angle of 120° is known to be the maximum value that a smooth surface may reach, and so far, no coating materials except for fluoro-containing coating materials have accomplished such a high level of hydrophobicity. In particular, as mentioned above, when the base material has a complicated shape or in case of a porous material, the foregoing coating method makes it possible to impart a high level of hydrophobicity or anti-adhesion property with no damage to the integrity or the porosity of the base material in an easy, simple, and economical manner.

Hereinafter, the embodiments are illustrated in more detail with reference to examples. However, the following are exemplary embodiments and therefore are not limiting.

### EXAMPLES

### Preparation Example 1

### Preparation of deca(aminopropyl)dodecaethoxydecasiloxane

Deca(aminopropyl)dodecaethoxydecasiloxane represented by the following chemical formula is obtained by the following procedure.

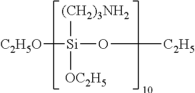

To a mixture of 1.62 g (0.09 mol) of distilled water and 100 ml of absolute ethanol, 22.14 g (0.1 mol) of 3-aminopropyl-triethoxysilane is added, and it is heated up to 80° C. while stirring and held at this temperature for 5 hours, distilling off ethanol while being maintained under vacuum. The yield is 99% of a theoretically possible amount; n_{D}²⁰=1.4496; and purity of the product according to the GLC data is 98%.

¹H NMR spectrum (in CDCl₃, 250 MHz, ppm): 0.62 m (20H, 10SiCH₂); 1.23 m (36H, 12CH₃); 1.54 m (20H, 10CH₂); 2.70 m (20H, 10NCH₂); 3.78 m (24H, 120CH₂)

### Example 1

The surface of a polyester film (1 cm×5 cm) is wetted with 2 ml of an ethanol solution containing 0.03096 g (2×10⁻⁵ mol) of deca(aminopropyl)dodecaethoxydecasiloxane as synthesized in Preparation Example 1, dried in air, heat-treated in an oven at 140° C. for 20 minutes, then washed with water and dried in air for 12 hours. The water contact angle value of the untreated film is 43°.

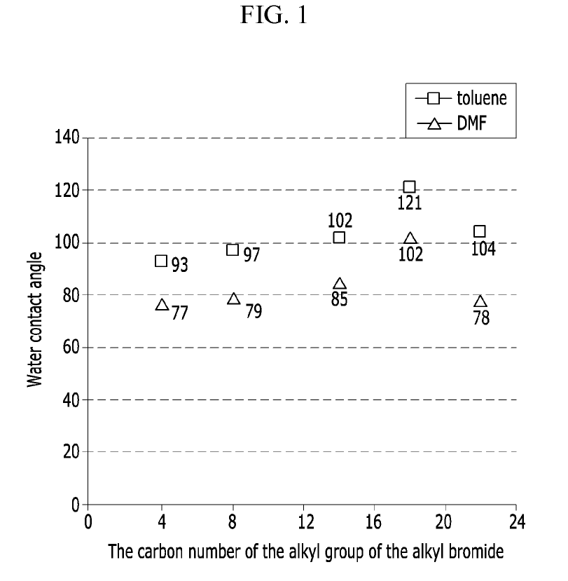

The modified surface of the film is wetted with a 10% toluene solution containing 0.0548 g (4·10⁻⁴ mol) of butylbromide (C₄H₉Br), dried in air for 12 hours, heat-treated in an oven at 140° C. for 20 minutes, washed with toluene, and heat-treated at 140° C. for 5 minutes. As illustrated in FIG. 1, the water contact angle value of the coating is 93°.

The water contact angle is determined by a tensiometer “Tracker IT Concept” (France) two minutes (in static conditions) after a water drop was placed on the surface of the base material.

### Example 2

The surface of a polyester film (1 cm×5 cm) is wetted with 2 ml of an ethanol solution containing 0.0242 g (1.56×10⁻⁴ mol) of deca(aminopropyl)dodecaethoxydecasiloxane as synthesized in Preparation Example 1, dried in air, heat-treated in an oven at 140° C. for 20 minutes, then washed with water and dried in air for 12 hours. The water contact angle value of the untreated film is 43°.

The modified surface of the film is wetted with a 10% DMF solution containing 0.0643 g (4.69×10⁻⁴ mol) of butylbromide, dried in air for 12 hours, kept in an oven at 140° C. for 20 minutes, then washed with absolute ethanol, dried in air, and heat-treated at 140° C. for 20 minutes. As illustrated in FIG. 1, the water contact angle value of the coating is 77°.

### Example 3

The surface of a polyester film (1 cm×5 cm) is wetted with 2 ml of an ethanol solution containing 0.03096 g (2×10⁻⁵ mol) of deca(aminopropyl)dodecaethoxydecasiloxane as synthesized in Preparation Example 1, dried in air, heat-treated at 140° C. for 20 minutes, then washed with water and dried in air for 12 hours. The water contact angle value of the untreated film is 43°.

The modified surface of the film is wetted with a 10% toluene solution containing 0.0772 g (4×10⁻⁴ mol) of octylbromide (C₈H₁₇Br), dried in air for 12 hours, kept at 140° C. for 20 minutes, then washed with toluene and heat-treated again at 140° C. for 5 minutes. As illustrated in FIG. 1, the water contact angle value of the coating is 97°.

### Example 4

The surface of a polyester film (1 cm×5 cm) is wetted with 2 ml of an ethanol solution containing 0.0242 g (1.56×10⁻⁴ mol) of deca(aminopropyl)dodecaethoxydecasiloxane as synthesized in Preparation Example 1, dried in air, heat-treated at 140° C. for 20 minutes, then washed with water and dried in air for 12 hours. The water contact angle value of the untreated film is 43°.

The modified surface of the film is wetted with a 10% DMF solution containing 0.0905 g (4.69×10⁻⁴ mol) of octylbromide, dried in air for 12 hours, heat-treated at 140° C. for 20 minutes, then washed with absolute ethanol, dried in air, and heat-treated at 140° C. for 5 minutes. As illustrated in FIG. 1, the water contact angle value of the coating is 79°.

### Example 5

The surface of a polyester film (1 cm×5 cm) is wetted with 2 ml of an ethanol solution containing 0.03096 g (2×10⁻⁵ mol) of deca(aminopropyl)dodecaethoxydecasiloxane as synthesized in Preparation Example 1, dried in air, heat-treated at 140° C. for 20 minutes, then washed with water and dried in air for 12 hours. The water contact angle value of the untreated film is 43°.

The modified surface of the film is wetted with a 10% toluene solution containing 0.111 g (4×10⁻⁴ mol) of tetradecylbromide (C₁₄H₂₉Br), dried in air for 12 hours, kept at 140° C. for 20 minutes, then washed with toluene and heat-treated again at 140° C. for 5 minutes. As illustrated in FIG. 1, the water contact angle value of the coating is 102°.

### Example 6

The surface of a polyester film (1 cm×5 cm) is wetted with 2 ml of an ethanol solution containing 0.0242 g (1.56×10⁻⁴ mol) of deca(aminopropyl)dodecaethoxydecasiloxane as synthesized in Preparation Example 1, dried in air, heat-treated at 140° C. for 20 minutes, then washed with water and dried in air for 12 hours. The water contact angle value of the untreated film is 43°.

The modified surface of the film is wetted with a 10% DMF solution containing 0.1068 g (4.69×10⁻⁴ mol) of tetradecylbromide, dried in air for 12 hours, heat-treated at 140° C. for 20 minutes, then washed with absolute ethanol, dried in air, and heat-treated at 140° C. for 5 minutes. As illustrated in FIG. 1, the water contact angle value of the coating is 85°.

### Example 7

The surface of a polyester film (1 cm×5 cm) is wetted with 2 ml of an ethanol solution containing 0.03096 g (2×10⁻⁵ mol) of deca(aminopropyl)dodecaethoxydecasiloxane as synthesized in Preparation Example 1, dried in air, heat-treated at 140° C. for 20 minutes, then washed with water and dried in air for 12 hours. The water contact angle value of the untreated film is 43°.

The modified surface of the film is wetted with a 10% toluene solution containing 0.1333 g (4×10⁻⁴ mol) of octadecylbromide (C₁₈H₃₇Br), dried in air for 12 hours, heat-treated at 140° C. for 20 minutes, then washed with toluene and heat-treated at 140° C. for 5 minutes. As illustrated in FIG. 1, the water contact angle value of the coating is 121°.

### Example 8

The surface of a polyester film (1 cm×5 cm) is wetted with 2 ml of an ethanol solution containing 0.0242 g (1.56×10⁻⁴ mol) of deca(aminopropyl)dodecaethoxydecasiloxane as synthesized in Preparation Example 1, dried in air, heat-treated at 140° C. for 20 minutes, then washed with water and dried in air for 12 hours. The water contact angle value of the untreated film is 43°.

The modified surface of the film is wetted with a 10% DMF solution containing 0.1563 g (4.69×10⁻⁴ mol) of octadecylbromide, dried in air for 12 hours, heat-treated at 140° C. for 20 minutes, then washed with absolute ethanol, dried in air, and heat-treated at 140° C. for 20 minutes. As illustrated in FIG. 1, the water contact angle value of the coating is 102°.

### Example 9

The surface of a polyester film (1 cm×5 cm) is wetted with 2 ml of an ethanol solution containing 0.03096 g (2×10⁻⁵ mol) of deca(aminopropyl)dodecaethoxydecasiloxane as synthesized in Preparation Example 1, dried in air, heat-treated at 140° C. for 20 minutes, then washed with water and dried in air for 12 hours. The water contact angle value of the untreated film is 43°.

The modified surface of the film is wetted with a 10% toluene solution containing 0.1588 g (4×10⁻⁴ mol) of behenylbromide (C₂₂H₄₅Br), dried in air for 12 hours, kept at 140° C. for 20 minutes, then washed with toluene and heat-treated at 140° C. for 5 minutes. As illustrated in FIG. 1, the water contact angle value of the coating is 104°.

### Example 10

The surface of a polyester film (1 cm×5 cm) is wetted with 2 ml of an ethanol solution containing 0.0242 g (1.56×10⁻⁴ mol) of deca(aminopropyl)dodecaethoxydecasiloxane as synthesized in Preparation Example 1, dried in air, heat-treated at 140° C. for 20 minutes, then washed with water and dried in air for 12 hours. The water contact angle value of the untreated film is 43°.

The modified surface of the film is wetted with a 10% DMF solution containing 0.183 g (4.69×10⁻⁴ mol) of behenylbromide (C₂₂H₄₅Br), dried in air for 12 hours, heat-treated at 140° C. for 20 minutes, then washed with absolute ethanol, dried in air, and heat-treated at 140° C. for 20 minutes. As illustrated in FIG. 1, the water contact angle value of the coating is 78°.

The results of the water contact angle obtained from the coatings of the foregoing examples confirm that the surface coating method as set forth above makes it possible to impart a high level of hydrophobicity to various materials. In particular, the coating including the siloxane polycondensate with a quaternary ammonium salt may have a water contact angle as high as 120° or higher even when it is prepared by using a tiny amount (e.g., a micro-mole) of the siloxane oligomer per one cm² of the surface of the material.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of coating a surface of a base material, the method comprising:
providing a base material comprising a surface;
applying a solution of a siloxane oligomer represented by Chemical Formula 1 to the surface of the base material and drying and/or heat-treating the surface comprising the siloxane oligomer applied thereto to obtain a siloxane-modified surface; and
applying a solution of a hydrocarbyl halide represented by Chemical Formula 2 to the siloxane-modified surface and drying and/or heat-treating the siloxane-modified surface comprising the solution of the hydrocarbyl halide applied thereto to form a coating comprising a siloxane polycondensate comprising a hydrocarbyliminoalkyl moiety or a quaternary ammonium salt-substituted hydrocarbyl moiety: 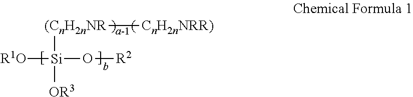
wherein R¹, R², and R³ are the same or different and are each independently hydrogen or a C1 to C10 alkyl group, R is the same or different and each is independently hydrogen or a C1 to C10 alkyl group, n is an integer of 1 to 5, a is an integer of 1 to 3, and b represents a polymerization degree of the siloxane oligomer, being an integer of 2 to 30;
Alk-X Chemical Formula 2
wherein Alk is a C4 to C24 alkyl group, a C4 to C24 alkenyl group, or a C4 to C24 alkynyl group, and X is F, Cl, Br, or I.

2. The method of claim 1, wherein the base material is an organic material, an inorganic material, or an organic-inorganic hybrid material, and comprises a hydroxyl group, a carboxyl group, or a combination thereof on the surface thereof.

3. The method of claim 1, wherein the siloxane oligomer represented by Chemical Formula 1 is oligo(aminopropyl)ethoxysilane, oligo(aminopropyl)methoxysilane, oligo(aminoethyl)methoxysilane, oligo(aminoethyl)ethoxysilane, oligo(aminobutyl)ethoxysilane, oligo(aminobutyl)methoxysilane, oligo(aminopentyl)ethoxysilane, oligo(aminopentyl)methoxysilane, an oligo(aminoalkyl)alkoxysilane represented by either of the following chemical formulae, or a combination thereof: 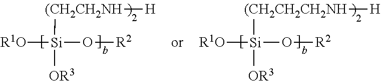
wherein R₁, R₂, and R₃ are the same or and are each independently hydrogen or a C1 to C3 alkyl group, and b is an integer of 2 to 30.

4. The method of claim 1, wherein the siloxane oligomer has a polymerization degree of about 4 to about 16.

5. The method of claim 1, wherein the hydrocarbyl halide is a C4 to C22 alkyl bromide, a C4 to C22 alkenyl bromide, a C4 to C22 alkynyl bromide, or a combination thereof.

6. The method of claim 1, further comprising preparing the solution of the siloxane oligomer by dissolving or dispersing the siloxane oligomer in an organic solvent that dissolves or disperses the siloxane oligomer.

7. The method of claim 6, wherein the organic solvent that dissolves or disperses the siloxane oligomer is a linear or branched C1 to C10 alcohol, a C3 to C10 ketone, a C3 to C10 ester, a linear or cyclic C3 to C10 ether, a C6 to C10 aromatic hydrocarbon, a C2 to C5 nitrile, a C2 to C10 sulfoxide, a C4 to C10 carbonate, or a combination thereof.

8. The method of claim 6, wherein the organic solvent that dissolves or disperses the siloxane oligomer is methanol, ethanol, n-propanol, isopropanol, n-butanol, acetone, butanone, methyl acetate, ethyl acetate, butyl acetate, tetrahydrofuran, dioxane, diethyl ether, methyl-butyl ether, benzene, toluene, xylene, acetonitrile, propylene carbonate, dimethylsulfoxide, or a combination thereof.

9. The method of claim 1, wherein the applied amount of the siloxane oligomer per cm² of the surface of the base material is less than or equal to about 1.0×10⁻³ mol.

10. The method of claim 1, wherein the surface of the base material having the solution of the siloxane oligomer applied thereto is dried and/or heat-treated at a temperature of about 20° C. or higher to provide the siloxane-modified surface comprising the siloxane oligomer or a polysiloxane derived from the siloxane oligomer, the siloxane or the polysiloxane being covalently bonded to the surface of the base material.

11. The method of claim 1, further comprising preparing the hydrocarbyl halide solution by dissolving the hydrocarbyl halide in a solvent that dissolves the hydrocarbyl halide, wherein the solvent optionally comprises an amide group represented by formula —C(═O)NH—.

12. The method of claim 11, wherein the solvent without an amide group represented by formula —CONN— that dissolves the hydrocarbyl halide is a linear or branched C1 to C10 alcohol, a C3 to C10 ketone, a C3 to C10 ester, a linear or cyclic C3 to C10 ether, a C6 to C10 aromatic hydrocarbon, a C2 to C5 nitrile, a C2 to C10 sulfoxide, a C4 to C10 carbonate, or a combination thereof, and the solvent comprising an amide group represented by formula —CONH— that dissolves the hydrocarbyl halide is dimethylformamide, diethylformamide, dimethylacetamide, diethylacetamide, N-methylpyrrolidone, or a combination thereof.

13. The method of claim 1, wherein the hydrocarbyl halide solution is applied to the siloxane-modified surface in an amount such that the applied amount of alkyl halide is greater than or equal to about 0.5 mol per one mole of an amine nitrogen of the siloxane oligomer.

14. The method of claim 1, wherein the siloxane-modified surface comprising the solution of the hydrocarbyl halide applied thereto is dried and/or heat-treated at a temperature of greater than or equal to about 20° C. to form the coating comprising the siloxane polycondensate, wherein the siloxane polycondensate comprises a repeating unit represented by Chemical Formula 3 or a repeating unit represented by Chemical Formula 4 and is covalently bonded to the surface of the base material: 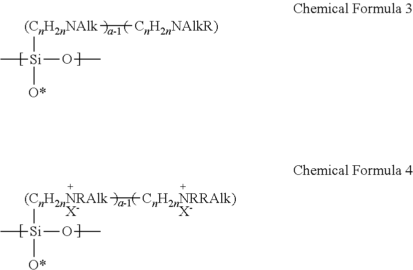
wherein R is the same or different and each is independently hydrogen or a C1 to C10 alkyl group, n is an integer of 1 to 5, a is an integer of 1 to 3, Alk is a C4 to C24 hydrocarbyl group, X is F, Cl, Br, or I, and each asterisk (“*”) independently represents a point of attachment to the surface of the base material, a hydrogen, or a C1 to C10 alkyl provided that at least one asterisk is a point of attachment to the surface of the base material.

15. A hydrophobic coating formed on a surface of a base material, comprising a siloxane polycondensate comprising a repeating unit represented by Chemical Formula 3 or a repeating unit represented by Chemical Formula 4, and the siloxane polycondensate is covalently bonded to the surface of the base material: 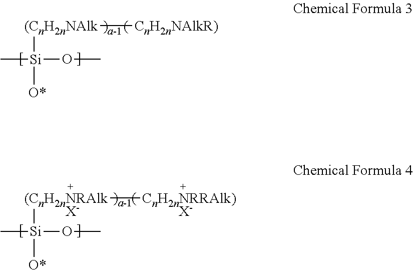
wherein R is the same or different and each is independently hydrogen or a C1 to C10 alkyl group, n is an integer of 1 to 5, a is an integer of 1 to 3, Alk is a C4 to C24 hydrocarbyl group, X is F, Cl, Br, or I, and each asterisk (“*”) independently represents a point of attachment to the surface of the base material, a hydrogen, or a C1 to C10 alkyl provided that at least one asterisk is a point of attachment to the surface of the base material.

16. The hydrophobic coating of claim 15, wherein the base material is an organic material, an inorganic material, or an organic-inorganic hybrid material, and comprises a hydroxyl group, a carboxyl group, or a combination thereof on the surface thereof.

17. The hydrophobic coating of claim 15, wherein the base material is a polymer, wood, leather, glass, a metal, a metal oxide, a metal nitride, a ceramic material, or a combination thereof.

18. The hydrophobic coating of claim 15, wherein Alk is a C4 to C22 alkyl group, a C4 to C22 alkenyl group, or a C4 to C22 alkynyl group, and X is Br.

19. The hydrophobic coating of claim 15, wherein the coating has a water contact angle of greater than or equal to about 90°.
